(19) United States
(12) Patent Application Publication
(10) Pub. No.: US 2011/0188667 A1
(43) Pub. Date: Aug. 4, 2011

(54) Hybrid/Electric Car Sound Symphony System

(75) Inventor: Lawrence J. Costello, West Roxbury, MA (US)

(73) Assignee: Lawrence Joseph Costello, West Roxbury, MA (US)

(21) Appl. No.: 12/820,388

(22) Filed: Jun. 22, 2010

Related U.S. Application Data
(60) Provisional application No. 61/222,258, filed on Jul. 1, 2009.

(51) Int. Cl. H04B 3/00

(52) U.S. Cl. 381/77

(57) ABSTRACT

Hybrid/Electric cars of the future will generate sound to alleviate safety concerns and as a convenience to the owners. The Hybrid/Electric Sound Symphony System (H/ESSS) will generate sound from hybrid/electric vehicles and coordinate the sound from other H/ESSS equipped nearby vehicles into a coordinated, harmonious effect.

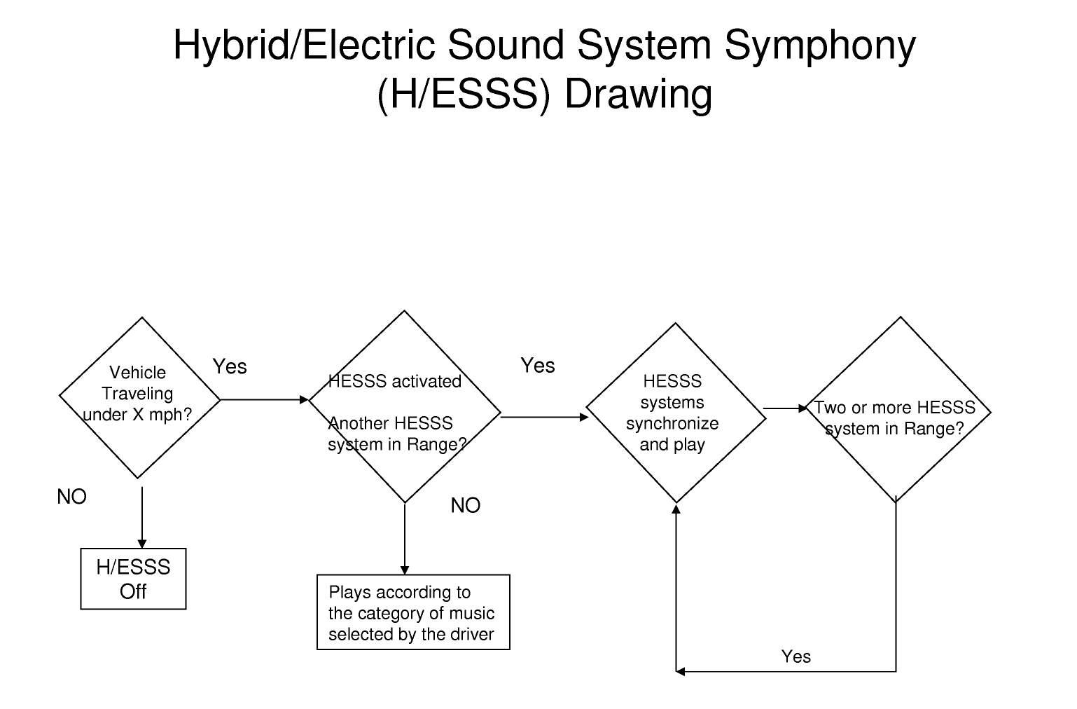

### CROSS-REFERENCE TO RELATED APPLICATIONS

Provisional application U.S. 61/222,258 filed by myself on Jul. 1, 2009.

### FEDERALLY SPONSORED RESEARCH

Not Applicable

### SEQUENCE LISTING OR PROGRAM

Not Applicable

### BACKGROUND

1. Field

This application relates to the automotive field and equipment for silent or very quiet electric/hybrid/fuel cell cars.

2. Prior Art

There is no prior art in this area. This is a new concept for automobiles.

Hybrid and/or electric cars (Hybrid/Electric) are coming under criticism for being too quiet. It has become a safety issue. People are accustomed to hearing cars and when they hear nothing, they assume there are no cars around. To illustrate the problem, a blind person on a street corner, not hearing typical car noise, could step in front of a moving hybrid/electric car. The safety issue is not limited to blind folks. New Hybrid/Electric owners sometimes forget their car is “on” since it is silent when parked, and very quiet while it is running. The quietness of the car is also dangerous to bikers and children.

To alleviate this issue, car designers are starting to think about incorporating the ability of the car to project or emit sound. Because this will be “artificially generated” sound, it doesn't have to necessarily sound like a car engine. In fact some consider engine noise to be more noise pollution than anything else. Some are thinking about allowing the car owner to project whatever sound they like (subject to volume constraints.) Why not classical music instead of the artificial sound of an internal combustion engine?

Hybrid/Electric car manufacturers will incorporate the ability to project pleasant sounds. I can imagine choosing from Classical music, Nature sounds (e.g. waterfalls or birds chirping) or other music types, jazz, oldies, etc. . . .

### BRIEF SUMMARY OF THE INVENTION

Hybrid/Electric cars of the future will generate sound to alleviate safety concerns and as a convenience to the owners. The Hybrid/Electric Sound Symphony System (H/ESSS) will generate sound from hybrid/electric vehicles and coordinate the sound from other H/ESSS equipped nearby vehicles into a coordinated, harmonious effect. Without the H/ESSS we will have annoying, uncoordinated noise at red lights and other spots where two or more hybrids are stopped.

### DRAWINGS

One drawing depicting a flowchart of how HESSS operates/engages.

### DETAILED DESCRIPTION

This invention is to take that concept a step further. Along with the speaker system to project digital sound, the automobile will also be able to hear (or sense) other Hybrid/Electric cars which are close by, or “in range.” The cars will combine their projected sounds to complement one another. For example, imagine five Hybrid/Electric cars stopped at a red light. Today it is quiet. Tomorrow, there could be a mini-symphony, with two cars playing the violins, one the bass, another the clarinet, and the last one on drums, playing the same piece of classical music.

The same concept could occur with “Nature sounds”. One car would sound like a waterfall, while others had crickets or birds chirping. The net effect will be to have a beautiful sound and not the noise pollution of internal combustion engines. Imagine two hybrids stopped at a red light, playing the classical “chopsticks” piece which takes two piano players to play at once. Other harmonious tunes and sounds will be coordinated as other vehicles in range “hear” one another and adjust accordingly. The Hybrid/Electric Sound Symphony System (H/ESSS) will detect other H/ESSS systems within range and synchronize their projected sounds. There are many different variations possible.

Cars are becoming more computerized. Dedicated Short Range Communication (DSRC) is an emerging technology that could be used for this invention. Bluetooth technology is another possibility. Vehicle to Vehicle communication concepts will emerge over time. It is appreciated that another communication system between vehicles could be used and still fall within the scope of this invention. This invention involves the external sound the vehicles will emit and “symphonizing” it into a harmonious effect.

Because of the power of microchips and their small size, my invention will take up very little space and may be integrated with other computers/processors inside the vehicle. This is why detailed hardware drawings are inappropriate.

I envision the system knowing what date it is and playing Patriotic symphonies on the 4^{th} of July, Holiday music at the end of the year, etc. Imagine several Hybrid/Electric cars at a red light on July 4^{th}, playing the Star Spangled banner in harmony!

The system will come preloaded with many songs/musical effects but also additional selections will be downloadable from the internet. The “symphony songs” are not just complete songs, but have individual parts which the vehicle will play in combination with other H/ESSS equipped vehicles. (Using the classical music as an example, each car could be ready to play the flute, clarinet or violin depending on when they join the symphony!)

The H/ESSS system will not play while the vehicle is traveling at high speeds. At some speed (e.g., 25 mph or higher) there is not a need to emit sound. The system will engage only at speeds lower than that. (Testing results or regulation in the future may influence the setting of that number.)

There will also be versions of songs to play when two cars are synchronized and the H/ESSS system will adjust the music to accommodate a third player instantly, communicating to the third car the exact point in the song to join in and adjusting the other two players to the correct “songsheet” if you will. In reality, the digital files in the systems will all accommodate this management in microseconds, so the net effect to a passerby is a harmonious sound.

It is important to note that this music is played outside the car. This is a feature to “replace” engine noise and therefore will not be too loud. This is not a replacement for the radio or CD player inside the car. The driver inside of the H/ESSS equipped vehicle could be listening to the radio and not the outside symphony.

Although the invention is inspired by the relative quiet/silence of electric/hybrid/fuel cell powered cars, it could be used by other vehicles as well.

As cars separate and move out of range, or speed up, they merely drop off the symphony. Since the H/ESSS is disengaged at X mph or over, it will be natural for the H/ESSS to play portions of music by itself, and portions with other vehicles.

I claim:

1. A system and method for an external sound generating system to play coordinated, synchronized, digital sound together among two or more vehicles. This is comprised of an external sound system, processor, memory, digital files, and a short range communication system which communicates among the vehicles in range.

2. Any system described herein.

3. Any process described herein.

4. I claim the benefits and priority of the provisional application U.S. 61/222,258 filed by myself on Jul. 1, 2009.
